(19) United States
(12) Patent Application Publication
(10) Pub. No.: US 2005/0201556 A1
(43) Pub. Date: Sep. 15, 2005

(54) Trick play of encrypted data in a conditional access signal

(75) Inventors: Albert Maria Arnold Rijckaert, Eindhoven (NL); Rudi Jaak Jozef Verslegers, Hasselt (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke PhilipsElectronics N.V.

(21) Appl. No.: 10/517,480

(22) PCT Filed: May 27, 2003
(86) PCT No.: PCT/IB03/02362

§ 371 Date: Dec. 7, 2004

(30) Foreign Application Priority Data
Jun. 12, 2002 (EP) 02077289.3

(51) Int. Cl. H04K 1/00

(52) U.S. Cl. 380/37

(57) ABSTRACT

An incoming data stream contains a stream of encrypted data and a stream of messages. Data in successive segments of the stream of encrypted data is decryptable with successive decryption information from the messages. The stream of encrypted data is stored and items with decryption information from the stream of messages are stored. Synchronization information is stored that links respective points in the stored stream of encrypted data to respective ones of the items with decryption information. The synchronization is stored so that it is retrievable independent of the stream. During trick replay a stored part of the stream of encrypted data is replayed in an abnormal temporal pattern. The items with decryption information are retrieved for the points in said stored part during said replaying. The retrieved items are combined with decryption information of the stream during replay at times selected under control of the synchronization information, the items which are combined being selected and/or a time when the items are combined with the stream being selected, dependent on the synchronization information and the abnormal temporal pattern.

The field of the invention is a data distribution system that allows for conditional access to the distributed data. The invention also relates to an apparatus for recording the distributed data and an apparatus for replaying recorded data.

U.S. Pat. No. 5,991,400 describes a data distribution system that realizes conditional access by means of distribution of a data stream that contains encrypted data. Subscribers of the system are provided with receivers. Each receiver is provided with a secure device, such as a smart card, that enables decryption of the distributed data.

Decryption makes use of control words that are normally distributed as part of the data stream in messages (called ECM's: ECM=Encryption Control Message) that are part of the data stream. The ECM's contain encrypted control words. Similarly, keys for decrypting the ECM's are distributed in messages (EMM's: Encryption Management Messages) that are part of the data stream. ECM's are generally the same for all subscribers, but the EMM's are subscriber specific. Therefore EMM's for a specific subscriber are transmitted much less frequently than EMM's in general.

The ECM's and EMM's are decrypted in the secure device of the receiver. Generally, the encryption used in these ECM and EMM messages allows for more tamper proof decryption of control words and keys than decryption of the data, but the price of this is that decryption of the control words and keys is generally slower than decryption of the data. In practice two control words or keys may be included in each ECM. One future control word for future data to allow some time to extract the control words or keys from the messages before the control word is actually needed. Also the control word needed currently or in the very near future is included in the ECM to allow decryption of the data soon after the receiver starts receiving the stream, e.g. during zapping by the subscriber. Information in the stream indicates which data should be decrypted with which key.

U.S. Pat. No. 5,991,400 describes recording and playback of the data stream for time-shifting purposes, i.e. to decrypt the stream at a later time than when it was distributed. Basically the same decryption mechanism is used for “live” and “time-shifted” playback of the data stream. However, the key from the EMM's for decrypting the ECM's may not be readily available from the part of the data stream that is played back, because EMM's for a specific subscriber are transmitted only sparingly. U.S. Pat. No. 5,991,400 solves this problem by means of additional measures to ensure that the key from the EMM's that is needed for decrypting the ECM's from a specific part of the stored data stream is available when that part of the data stream is played back. For example, the EMM that is needed to decrypt the ECM's of a part of the data stream is stored so that it can be retrieved separately (not just as part of the stream), the EMM is retrieved and supplied with the part of the data stream that it is played back. The ECM's are supplied as part of the stream: the ECM's occur so frequently that they are readily available.

Conventional recording devices, such as video recorders, which store plain data (not encrypted) usually provide for various “trick play” modes, in which the data is played back in an abnormal temporal pattern. Examples of trick play are display of a speeded up version of video data, slow motion, reverse display etc. In the trick play modes the conventional recording devices access the recorded data selectively, reading only a part of the recorded information that is actually needed, or in an abnormal order.

Playback in an abnormal temporal pattern leads to difficulties in case of an encrypted stream. In case of forward playback in an abnormal temporal pattern, such as during fast forward, it would be possible in principle to decrypt the stream entirely and to use the decrypted stream for fast play back. However this requires much faster hardware than for normal playback. When the stream is played back in reverse faster hardware would already be needed for playback at normal speed.

Amongst others it is an object of the invention to provide efficient for playback of encrypted data from a data stream in an abnormal temporal pattern.

Amongst others it is an object of the invention to provide for storage of encrypted data with a reduction of the amount of decryption information that needs to be stored.

The invention provides for a method according to claim 1. According to the invention synchronization information is added during storage that links respective points in the stored stream of encrypted data to respective items with decryption information, such as ECM's. This is used during replay in an abnormal temporal pattern. The items of decryption information are retrieved and replayed at a time when they are needed for decryption of the encrypted data, as determined from the synchronization information, rather than at a time when data from their original positions in the stream is replayed. Thus a trick play stream may be generated with selected or rearranged temporal parts of the original streams and resynchronized items of decryption information that permit normal decryption in spite of the rearrangement. During fast forward only those items that are needed for the parts of the stream that are replayed may be supplied and/or the item with decryption information for a first part of the stream may be supplied concurrent with earlier or later parts of the stream than during playback in a normal temporal pattern, so as to allow a normal time for processing the items with decryption information.

Preferably, the items of decryption information are stored separately retrievable from the stored stream, not among the stored stream at the positions where they were originally received. This allows processing of the items of decryption information during storage (for example decryption and reencryption with another key) without use of a buffer memory to store of the stream temporarily until the items are available.

In an embodiment of the method according to the invention only items with decryption information from subsampled ones of the messages are stored for replay. This minimizes the need to search for the appropriate item that has to be used at a certain point in time during trick play.

The synchronization information links each item to a plurality of positions in the stream. By subsampling the items during recording the amount of storage space needed for storing the items can be reduced. By maintaining synchronization information that links points in the stream to the sub-sampled items the correct decryption information can nevertheless be replayed, repeatedly replaying the same item for different positions in the stream if necessary.

In an embodiment each subsampled item is selected in a predetermined relation to a transition in the stream after which the decryption information changes. Only the sub-sampled items are stored and replayed. In MPEG streams for example, a toggle in the tableID indicates such a transition, therefore detection of such a toggle can be used to detect the transition. An item of decryption information is sampled in a fixed relation to the detected transition, for example, the first item received after such a transition is sampled (of course instead of the first item after the transition the nth item may be taken, when it is certain that at least n items normally occur between successive transitions).

Sub-sampling triggered by transitions after those transitions simplifies the determination of the synchronization information during trick play, since it is ensured that at each position in the stream it suffices to look backward to the last previous transition to locate the relevant sub-sampled item. This ensures a straightforward relation between the sampled items and points in the stored stream that require the items for decryption. No look-ahead mechanism is needed to link points in the stream to events that occur later in the stream. In particular, when each items of decryption information contains more than one successively valid key for decrypting messages, it is ensured that a sampled item is chosen that remains valid independent of the timing relation between points in time at which the transmitted keys change and points in time where the keys that have to be used for decryption change.

During normal replay it follows directly from the stream which of the subsampled items of decryption information should be replayed when relative to the stream and how the sub-sampled item should be used. However, during replay in an abnormal temporal pattern (trick play) not all of the stream is accessed, so that information that is relevant to enable decryption may be missed. Therefore additional measures are preferred if it has to be ensured that all replayed parts of the stream can be decrypted.

In one embodiment the stream is examined when it is stored to determine the positions in the stream that may have to be accessed during replay in the abnormal temporal pattern. Synchronization information is provided specifically for those positions. An MPEG stream for example contains image frames that are coded independent of other frames (I-frames) and image frames that are coded dependent on other frames (B frames and P frames). During some forms of trick play only I frames will be needed. Therefore, preferably synchronization information is stored that allows the selection of the appropriate sub-sampled item of decryption information for each I-frame during replay. This may be in the form of a table with pointers to positions of the I-frames and associated pointers to items of decryption information.

However, this requires access to the stream when it is stored. This may be undesirable because it consumes computational capacity, obstructing for example replay of another stream simultaneously with storing, particularly when the stream has to be decrypted to store it.

In one embodiment solves this problem by storing information that associates the subsampled items with intervals in the stored stream following the position where the items were sub-sampled. On replay of information from a position in the stream, the relevant interval is determined and the sub-sampled item associated with the interval is replayed.

In one embodiment this is implemented by using a list of data pointers to selected parts of the stream of encrypted data in the synchronization information. Items of decryption information that enable decryption of the encrypted data following the position pointed at by the pointer are associated with the pointer. During replay it may be detected whether replay crosses a position in the stream to which such a pointer points and in that case the encrypted data associated with that pointer is supplied during replay.

In another embodiment pointers to storage locations that contain or will contain relevant items of decryption information are inserted in the stream during storage, at points in the stored stream where the stream originally contained decryption information (albeit not a subsampled item of decryption information). This form of synchronization information allows items of decryption information to be retrieved and added during replay of the stored encrypted data stream triggered by passage over such points.

These and other advantageous objects and aspects of the method and apparatus according to the invention will be described in more detail using the following figures.

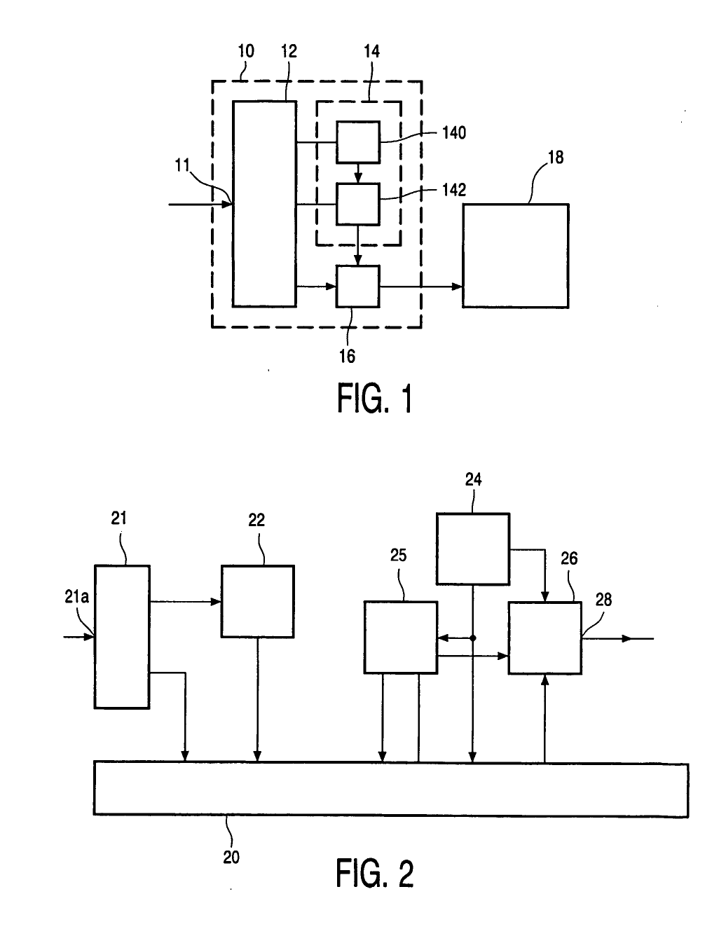

FIG. 1 shows a prior art conditional access apparatus;

FIG. 2 shows a conditional access apparatus with a recording medium;

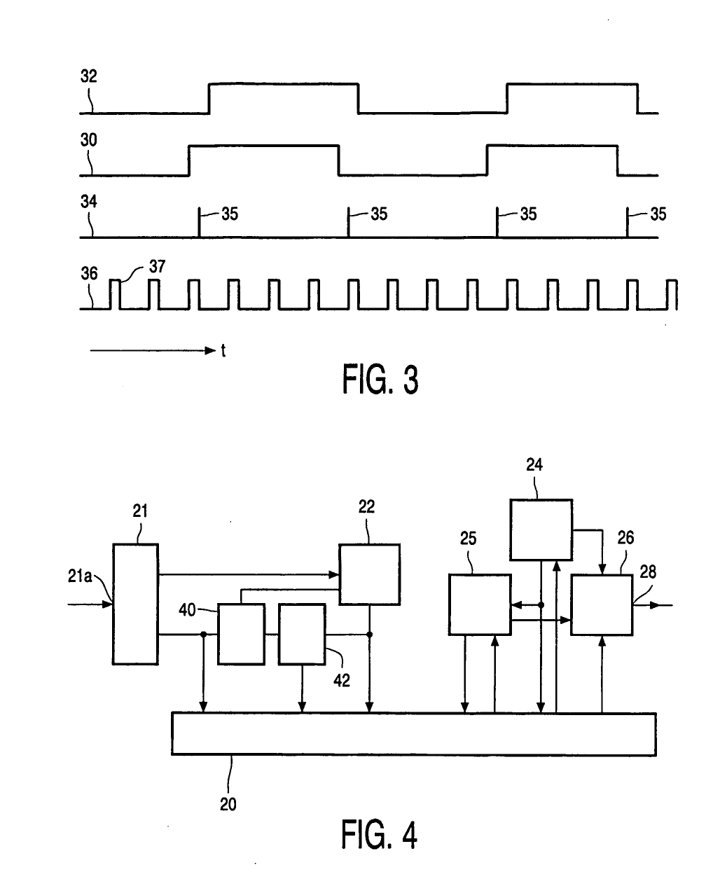

FIG. 3 shows temporal relations between information in a data stream;

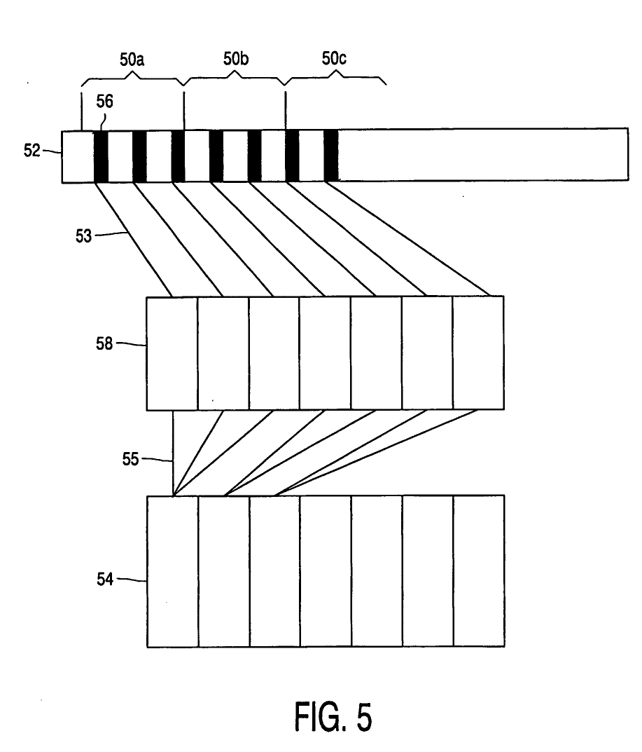

FIG. 4 shows an embodiment of a conditional access apparatus;

FIG. 5 shows a data structure;

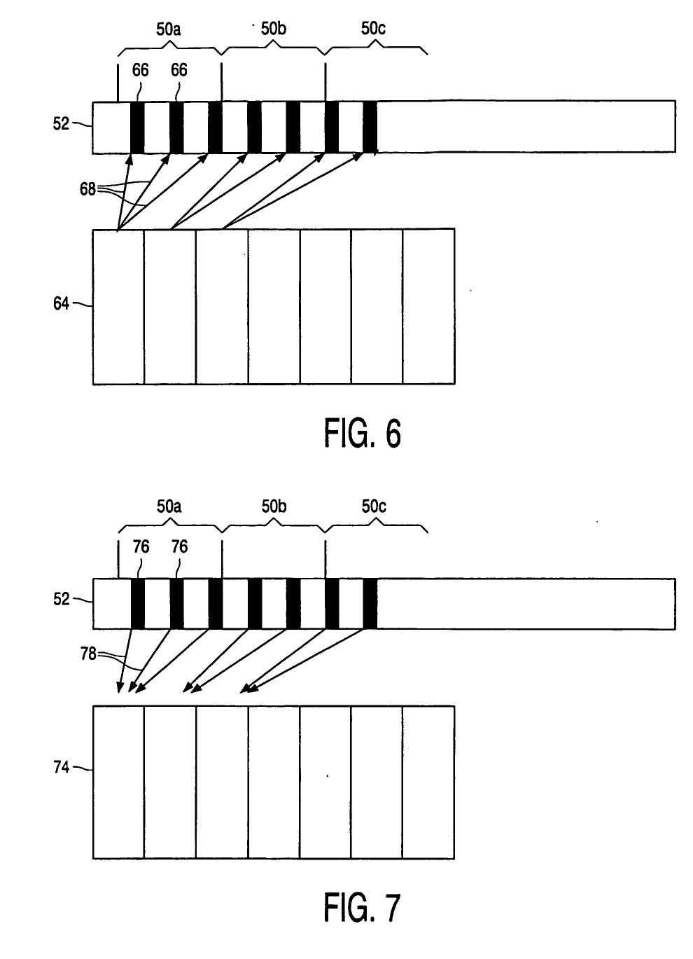

FIG. 6 shows a data structure;

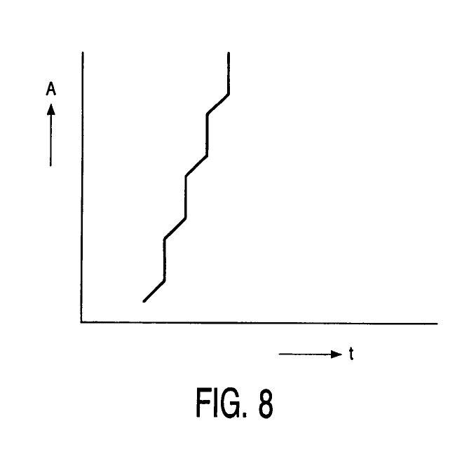

FIG. 7 shows a data structure;

FIG. 8 illustrates the use of encrypted data during trick mode replay.

FIG. 1 shows a conditional access apparatus. The apparatus contains a reception unit 10, such as a set-top box and a rendering device 18, such as a television set. The reception unit 10 has an input 11 for receiving an input signal from for example a cable TV system or a satellite broadcast receiving unit, a demultiplexer 12, a secure device 14 (such as a smart card) and a data decryption unit 16. A first output of demultiplexer 12 is coupled to rendering device 18 via decryption unit 16. Secure device 14 contains an EMM processing element 140 and an ECM processing element 142. A second and third output of demultiplexer 12 are coupled to the EMM processing element 140 and the ECM processing element 142 respectively. EMM processing element 140 has an output coupled to ECM processing element 142. ECM processing element 142 has an output coupled to decryption unit 16. (Although EMM processing element 140 and ECM processing element 142 are shown separately, their function may in fact be implemented using different program parts running on the same microprocessor in secure device 14).

In operation reception unit 10 receives a data stream from input 11. The data stream contains encrypted data, entitlement control messages (ECM's) and entitlement management messages (EMM's), multiplexed in the data stream. The ECM's contain control words for decrypting the encrypted data and the EMM's contain entitlement information, including keys for decrypting control words from the ECM's. Demultiplexer 10 demultiplexes encrypted data, ECM's and EMM's and outputs encrypted data (or a part thereof) to decryption unit 16, ECM's to ECM processing element 142 and EMM's to EMM processing element 140. ECM processing element 142 extracts control words from the ECM and supplies these control words to decryption unit 16. Decryption unit uses the control words to decrypt the encrypted data and supplies decrypted data to rendering device 18, which displays images coded by the data on a display screen and/or renders audio data.

EMM processing element 140 extracts entitlement information from the EMM's and uses this information to control for which encrypted data ECM processing element 142 supplies control words to decryption unit 16. EMM processing element 140 also obtains decryption keys from the EMM's and supplies these keys to ECM processing element 142 for use in decryption of the control words from the ECM's.

Recording Streams of Encrypted Data

FIG. 2 shows a conditional access apparatus with a mass storage unit 20, such as a magnetic or optical disk, a tape recorder or even semi-conductor memory. A recording side 21, 22 and a play-back side 24, 25, 26 are shown (for the sake of clarity separate recording and playback sides are shown, but it will be understood that the hardware that implements the recording side and the playback side may in fact overlap to a considerable extent; also, although various separate inputs and outputs to medium 20 are shown for clarity one or more of the inputs and/or output may in fact be combined).

The recording side contains a demultiplexer 21 and a decryption information recording unit 22. The demultiplexer 21 has an input 21a coupled to an input of the apparatus, which may be coupled for example to a cable TV system or a satellite broadcast receiving unit. Demultiplexer 21 has outputs coupled to the mass storage unit 20 and to decryption information recording unit 22. Decryption information recording unit 22 has an output coupled to mass storage unit 20.

The playback side contains a control unit 24, a decryption information access unit 25 and a reception unit 26. The control unit 24 has a control output coupled to reception unit 26 and an address selection output coupled to mass storage unit 20 and decryption information access unit 25. Decryption information access unit 25 has inputs and output coupled to mass storage unit 20 and an output coupled to reception unit 26.

The conditional access apparatus of FIG. 2 is designed to receive a data stream of the type that can be handled by the reception unit 10 of FIG. 1, record encrypted information from this data stream in mass storage device 20 and play back the information at a later time from mass storage device. During playback the information is decrypted at the playback side.

FIG. 3 shows temporal relations between information in the data stream. The data stream contains encrypted data and decryption information for decrypting the encrypted data (decryption information is included in for example ECM's and EMM's). The encrypted data is segmented into successive segments of for example 10 seconds. Each segment requires its own control word to decrypt the data in the segment. Generally the control words of different segments are different. The data stream contains information that identifies different segments. FIG. 3 shows a signal 30 that toggles each time a different segment starts. In DVB this is indicated by the scrambling control bits in the packet header.

The decryption information supplies the control words (for example in ECM's). Typically each control word is supplied a number of times distributed over the segment for which it is needed. This ensures that each control word will be available on short notice when a subscriber selects the data stream. Moreover the control word is preferably also supplied prior to the segment. This allows time to decrypt the control word before it is needed. Thus time intervals are created in each of which the control word for a respective segment is supplied. These time intervals do not coincide with the segments. The final part of a time interval in which one control word is supplied generally overlaps with the initial part of a next time interval in which the next control word is supplied. In each ECM for example two control words are usually included, one for a current segment and one for a next segment. When the content of the ECM's changes, the oldest control word is omitted and a next control word is included.

A second signal 32 FIG. 3 illustrates the time intervals. Each control word is supplied during a whole period of the second signal 32. At each transition of the second signal 32 a new control word starts to be supplied and an oldest control word stops being supplied. Preferably the stream contains information from which the transitions of the second signal 32 can be determined. In DVB this is indicated by the Table-ID.

It should be noted that transitions in the first signal 30 preferably do not need to coincide with transitions in the second signal 32. That is, the time that encrypted data starts to come in for which a new control word is needed does not in general coincide with the time when a new control word starts to be supplied. This relaxes the timing requirement on the data stream.

The apparatus of FIG. 2 extracts encrypted data and decryption information from the stream received at input 21a, at least when a user of the apparatus provides a control signal to do so. Demultiplexer 21 writes the encrypted data to mass storage unit 20. Decryption information recording unit 22 writes items of decryption information to mass storage unit 20. The items of decryption information are written so that they can be accessed separately from the encrypted data, that is, they need not be accessed as part of a data stream at a predefined position in that data stream corresponding to their position in the original data stream received at input 21a.

Decryption information recording unit 22 writes items of decryption information to mass storage unit 20 in encrypted form. For this, the original encrypted decryption information (e.g. a copy of an ECM) may be used, or, alternatively, decryption information recording unit 22 may first decrypt the decryption information and re-encrypt it with some key before writing it to mass storage unit 20. The latter has the advantage that the original authorization key from the EMM's is no longer needed to decrypt the control words. This authorization key may not be available at the time of replay, or at least it might require considerable overhead if this authorization key would have to be used at that time. The key that is used for re-encryption may be a key that is local to the apparatus. The apparatus may be entitled to use this key indefinitely, or only for a limited period during which replay is permitted.

In addition to the decryption information, decryption information recording unit 22 writes synchronization information to mass storage unit, which links the items of synchronization information to points in the stream of encrypted data.

FIG. 4 shows an embodiment in which the apparatus contains a decryption unit 40 for decrypting the stream of encrypted data concurrently with storing the stream. In this embodiment the apparatus contains an isolated frame detection unit 42 for locating frames of a video signal that are described in isolation in the signal decrypted from the stream of encrypted data. In FIG. 3 a fourth signal 36 is shown, illustrating the encrypted data stream with parts 37 that contain such isolated frames. As is well known, from MPEG signals for example, a sequence of images can be compressed by providing information describing some frames (I frames) in isolation and other frames (B frames and P frames) in terms of changes relative to other frames.

In the embodiment of FIG. 4 decryption information recording unit 22 writes items of decryption information each containing control words of a respective ECM into mass storage unit 20. The control words are written in encrypted form, as described for FIG. 2. The isolated frame detection unit 42 writes access information into mass storage device 20.

FIG. 5 shows an example of a data structure of the access information. The figure shows the stored stream of encrypted data 52, containing parts of the encrypted data that describes I frames (e.g. 56). Different segments 50a-c of the stream 52 are indicated. Each segment 50a-c requires its own control word to decrypt the encrypted data in the segment. The figure also shows a block 54 of stored items of decryption information. Furthermore, a block 58 of access information is shown. The access information addresses respective parts of the stream 52 of encrypted data that contain isolated frames and corresponding items of decryption information that may be used to decrypt each part.

For example, for each detected isolated frame a pair of addresses (X,Y) is stored in an entry in the block of access information 58. The addresses X,Y constitute pointers 53, 55 addressing locations in mass storage unit 20 that store encrypted data that contain an isolated frame and an item of decryption information for that encrypted data respectively. The addresses (X, Y) may be absolute addresses for mass storage unit, or relative addresses or counter values, indicating a position within relevant stored information blocks 52, 54 etc.

During replay in certain trick modes the isolated frames will be used to replay the stream, omitting other frames. However, it will be understood that the invention is not limited to the use of isolated frames for this replay. Parts of the data stream that can otherwise be used for trick play may be used instead. In this case isolated frame detection unit 42 may be replaced by a unit for detecting any other type of relevant information in the stream of data, and the apparatus provides pointers to parts 56 of the stream 52 of encrypted data that contain this type op information.

Linking Decryption Information to Points in the Stream

Various methods may be used to link the items of decryption information to points in the stream of encrypted data, also when the embodiment of FIG. 4 is not used.

FIG. 6 shows an example of a data structure used in one embodiment. The figure shows a stream 52 of encrypted data and a block 64 of items of decryption information. Block 64 contains pointer information to locations 66 in the stream 52. Arrows 68 illustrate that the pointer information points to locations 66 in the stream 52.

In this embodiment decryption information recording unit 22 records a position in the encrypted data stream associated with the decryption information in each item. In one further embodiment this may be a pointer to stored encrypted data that was received immediately adjacent at the position of the pointer in the incoming stream. Recording of pointers to locations in the stream enables playback of the decryption information with the same timing relative to the encrypted data as at the time of original reception.

As will be described in the following the decryption information in an item of block 64 may correspond to decryption information in a plurality of messages from the stream, only one item of decryption information being stored for that plurality. In this case, it may be sufficient to supply the encryption information from the item only once during replay, but for security reasons it may be necessary to replay the decryption information at each point where the original stream contained a message with decryption information.

In an embodiment where decryption information recording unit 22 only stores one item for a plurality of messages, therefore, decryption information recording unit 22 detects positions of encrypted data in the incoming stream where messages with encryption information corresponding to the item occur and decryption information recording unit 22 stores information about a plurality of pointers 68 in association with the item, the pointers 68 pointing to positions in the stream of encrypted data where messages with encryption information corresponding to the item occurred in the incoming stream.

In another embodiment time-stamp information may be stored instead of the one or more pointers 68. The time stamp information specifies a time value at which the decryption information should be played back. This makes it possible to supply the decryption information at time points determined by replay of the stream. In this embodiment decryption information recording unit 22 samples the time stamp from a time stamp counter (not shown) that is updated with progression of the incoming stream. In the case of prior art MPEG data in the stream for example, the stream contains information that makes it possible to assign time values to different points in the stream. Decryption information recording unit 22 may use these time values.

FIG. 7 shows an alternative data structure, in which decryption information recording unit 22 stores pointer information 76 with the stored stream of encrypted data 52. The pointer information 76 points (as illustrated by arrows 78) items of decryption information in a block 74 of such items. Each element of pointer information 76 is stored at respective position among the encrypted data 52 that corresponds to the item of encryption information in block 74, in any of the ways described in the preceding. This enables retrieval of the corresponding item during playback so that the decryption information from the original stream is replayed in substantially the same relative timing relationship to the encrypted data 52 when that encrypted data 52 is played back.

This too can be realized in various ways. In one embodiment decryption information recording unit 22 inserts messages 76 with the pointer information among the encrypted data 52, so that effectively the incoming stream from input 21a is stored in mass storage unit 20, except that the messages with decryption information are replaced by messages with pointer information. A special so-called “PID” (Packet ID) may be used for this. In a conventional conditional access stream it is known to structure the stream into packets of data, each having a PID. Different PID values correspond to separate substreams, such as an image stream, an audio stream etc. Tables are transmitted that specify the relation between PID values and streams. During decryption of the stream a receiving unit selects packets according to PID value. When the pointer information is contained in packets with a PID that is specific to pointer information it is easy to select the pointer information from the stream on replay.

In another embodiment demultiplexer 21 stores the original messages with the encrypted data in mass storage unit 20. Decryption information recording unit 22 replaces part of the messages by pointer information. In this way, it is straightforward to maintain the original timing during replay.

For this embodiment it is desirable that the service provider that broadcasts the stream reserves space in the messages with decryption information for inserting the pointer information. The service provider may even insert the pointer information into the stream. That is, the service provider may broadcast a stream that contains encrypted data and messages with decryption information to decrypt encrypted data from segments of the stream, wherein the messages contain pointer information that identify a rank number of the message during transmission of a program (the first message having rank number “1”, the second message rank number “2” etc.). Alternatively the pointer information may specify the rank number of the decryption information in the message, this rank number being incremented each time when messages with new decryption starts being included in the messages. When decryption information recording unit 22 stores the items of decryption information so that they can be retrieved using this pointer information, this pointer information may be used in an apparatus as shown in FIG. 2 to retrieve the items.

The service provider may even provide the items of decrypted information. In that case decryption information recording unit 22 may be omitted. The items needed to decrypt a recorded program may be transmitted by the provider to the subscriber as part of the stream, or via a separate information exchange, for example via a telephone line or via the Internet. Thus, the service provider may selectively enable subscribers to replay recorded data, for example after payment of a fee.

Preferably the items of decryption information are not stored among the encrypted data. This allows decryption information recording unit 22 to decrypt and encrypt the decryption information for later use, without having to buffer encrypted data during decryption and encryption.

Sub-Sampling

In embodiments of the apparatus of FIG. 2 or 4 decryption information recording unit 22 stores all ECM's in mass storage unit 20. However, this may lead to considerable overhead when ECM's with the same control words are contained frequently in the data stream. In a further embodiment decryption information recording unit 22 effectively subsamples the ECM's, storing control words only from some ECM's. In one version of this embodiment the subsampling rate (the fraction of ECM's that is used) may have any value, as long as at least one ECM is sampled in each half period of the second signal.

In a preferred embodiment decryption information recording unit 22 triggers subsampling of the ECM's upon detection of transitions in the content of the ECM's, i.e. on the edges of the second signal 32. Preferably the first ECM after such an edge is used to store the item of decryption information. A third signal 34 in FIG. 3 indicates sampling points 35 where the ECM's are sampled in this way. When no ECM contains a control word for past encrypted data, sampling just behind transitions of the second signal 32 has the advantage that the samples allow decryption of subsequent encrypted data that is encrypted for decryption with the currently valid and the next control word. Alternatively, an ECM at a predetermined rank order after the edge (e.g. the fifth or the tenth ECM after the edge) may be used. The exact rank order does not matter as long as it is known that at least the message is repeated the corresponding number of times in the incoming data stream from input 21a.

Replay

During replay, control unit 24 determines which parts of the stream of encrypted data are retrieved from mass storage unit 20 and when. Control unit 24 does so by sending address information to mass storage unit 20, such as an address, a disk or tape position indicator of the required encrypted data. In response, mass storage unit 20 outputs the required data to receiving unit 26. At the same time decryption information access unit 25 detects which item of decryption information corresponds to the accessed data and whether it is necessary to supply decryption information from that item to receiving unit 26, for example because that decryption information has not yet been supplied.

There are various possible methods of determining whether decryption information must be supplied from an item of decryption information. For example, decryption information access unit 25 may monitor the addresses of the accessed encrypted data, and if the addresses pass a point for which an item has been stored, decryption information access unit 25 supplies decryption information from that item to receiving unit 26. Decryption information access unit 25 may use indications such as a single address value (or position value) per item indicating a position in the stream for the item, or a plurality of address values per item, indicating different positions in the stream where the item may be supplied. Thus the timing of the original stream can be constructed very accurately.

In the case where time stamps are stored in association with the items, decryption information access unit 25 may supply the time stamps at a time when a time counter (not shown) at the replay side reaches the value of the time stamp. (The time counter may be used in a conventional way to control correct timing of replay of the encrypted data).

As an alternative, decryption information access unit 25 may detect pointers to items of encryption information from among the retrieved encrypted data, loads the item if it has not yet been loaded and supplies the decryption information from the item to receiving unit. In the case where messages with pointer information are stored among the encrypted data, for example, decryption information access unit 25 may detect these messages (for example from the PID of these messages) and extract the pointer information. Decryption information access unit 25 uses the extracted pointer information to select the corresponding item of decryption information and supplies that information to receiving unit 26.

Receiving unit 25 basically operates in the same way as receiving unit 10 of FIG. 1. processing encrypted data and messages with decryption information. However, it may not be necessary to use demultiplexer 12, since decryption information and encrypted data is already retrieved separately from mass storage unit 10.

Normally, the encrypted data is played back in the temporal pattern in which it was received at input 21a, that is in a sequence and at a speed required for normal viewing.

Trick Play

The apparatus of FIG. 2 supports trick mode replay. Trick mode replay includes for example one or more of fast forward display, reverse play display, slow motion etc. Generally, during trick mode replay data from the stream is output to a rendering device in an abnormal temporal pattern, that is, not at normal speed or in a backward temporal direction or periodically skipping part of the stream. (In some special types of apparatus, the normal mode may not even be supported, the apparatus allowing access only in some trick modes, e.g. when the subscriber has not (yet) paid for viewing in the normal mode).

FIG. 8 illustrates access to mass storage unit 20 during fast forward. Time “t” is plotted horizontally and addresses “A” that represent the time of playback during normal mode playback are plotted vertically. During trick mode play control unit 24 supplies advancing addresses A to mass storage unit 20, periodically skipping a range of addresses.

Decryption information access unit 25 supplies decryption information needed to decrypt the retrieved encrypted information. For example, decryption information access unit 25 may retrieve a list of points in the stream of encrypted data for which items of decryption information are stored, the list containing associated items of decryption information or pointers thereto. In this case decryption information access unit 25 monitors the addresses of the encrypted data that will be supplied by control unit 24. When access unit determines that the addresses are about to access addresses past a point for which decryption information is stored decryption information, access unit 25 supplies the decryption information from the associated item of decryption information to receiving unit 26.

Preferably, the access unit 25 retrieves the decryption information at a selected point in time so that this point in time is followed by at least a predetermined time interval before the encrypted data is supplied. That is, the same predetermined time interval is available to decrypt the item of decryption information, independent of the speed of replay.

In the embodiment of FIG. 4, where specific frames have been identified in the encrypted data prior to retrieval from mass storage unit 20, control unit 24 may retrieve encrypted data containing the identified frames. In this case, control unit 24 first retrieves stored pairs of addresses (X,Y) for a section of encrypted data, then supplies addresses to mass storage unit 20 to retrieve encrypted data according to the address X, and then supplies address Y of the decryption information to decryption information access unit 25 to command supply of the corresponding decryption information to receiving unit 26.

Preferably the apparatus creates a delay between supply of the decryption information and the corresponding encrypted data. This may be realized for example by providing a buffer (not shown) between mass storage unit 20 and receiving unit 26 to buffer the data during said delay, or by supplying information about addresses from which it is intended to retrieve encrypted information early to decryption information access unit 25. This allows decryption information access unit 25 to supply decryption information in advance so that receiving unit 26 has time to decrypt the control words before they are needed.

In some types of trick mode play (e.g. reverse play back) the encrypted data may be retrieved at least partially in reverse order. In such a mode decryption information access unit 25 preferably determines points in the encrypted data where an item of decryption information would become valid during forward play. When play back passes such a point in reverse direction decryption information access unit 25 selects an item of decryption information that would chronologically be a last preceding item before that point during normal play. Obviously other methods of selecting the item may be used, such as associating items with intervals starting and ending at respective points, and detecting whether play back will access data in such an interval to select the associated item. Decryption information access unit 25 then outputs the selected item for use during reverse play. (Of course, although useable, this is not needed in the embodiment of FIG. 4, where the relevant item can be determined directly from the retrieved data).

In this way the apparatus allows for replay and/or trick mode replay of stored encrypted data. The mass storage unit 20 does not need to be tamperproof: replaceable memories, discs or tapes may be used. Preferably parts of the receiving unit 26 are made tamper proof (for example by using a secure device, such as a smart card, to decrypt control words), as well as, in the case of the embodiment of FIG. 4, the decryption unit 40. It will be appreciated that, for trick play, decryption information access unit 25 preferably uses pointer information to locations in the stream of encrypted data that can be retrieved separately from the stream of encrypted data, or at least without having to retrieve the stream of encrypted data in its entirety to search for pointer information. This reduces the amount of information that needs to be retrieved from mass storage unit 20. The embodiments where pointer information is stored in association with items of decryption information satisfy this requirement.

Other Aspects

It will be appreciated that the invention is not limited to the embodiments shown. For example, although it is preferred, for ease of access, that both encrypted data and the items of decryption information are stored in the same mass storage unit 20, this is of course not necessary. A separate memory may be used for items of decryption information. Also, although the items of decryption information are preferably retrieved as playback progresses, it is also possible to retrieve all relevant items for a recorded stream as a block in advance. This is facilitated by the use of subsampling to select the items that are stored in the first place. By using items that have been preloaded as a block, decryption information access unit 25 is able to respond quickly to the addresses of encrypted data that control unit 24 selects for replay.

1. A method of processing an incoming data stream that contains a stream of encrypted data and a stream of messages, data in successive segments of the stream of encrypted data being decryptable with successive decryption information from the messages, the method comprising
storing the stream of encrypted data;
storing items with decryption information from the stream of messages;
storing synchronization information linking respective points in the stored stream of encrypted data to respective ones of the items with decryption information, the synchronization being stored so that it is retrievable independent of the stream;
replaying a stored part of the stream of encrypted data in an abnormal temporal pattern;
retrieving the items with decryption information for the points in said stored part during said replaying;
combining the retrieved items with decryption information with the stream during replay at times selected under control of the synchronization information, the items which are combined being selected and/or a time when the items are combined with the stream being selected, dependent on the synchronization information and the abnormal temporal pattern.

2. A method according to claim 1, wherein the stream of messages contains a plurality of messages that repeat the same decryption information, the method comprising
subsampling messages from said stream of messages, only items with decryption information from subsampled ones of the messages being stored, and
the synchronization information linking groups of points in the stored stream of encrypted data to respective ones of the subsampled items.

3. A method according to claim 2, the method comprising
detecting a transition after which the messages contain decryption information different from decryption information in messages before the transition;
subsampling at least one of the subsampled messages at a predetermined position relative to the transition.

4. A method according to claim 1, wherein the method comprises
constructing a list of data pointers to selected parts of the stream of encrypted data, each data pointer being associated with a selected one of the items of decryption information that enables decryption of the encrypted data pointed at by the pointer;
determining, during replay, whether replay will access encrypted data in the part pointed at by a particular pointer in said list;
upon said determining using the list to supply decryption information from the item associated with the particular pointer.

5. A method according to claim 1, wherein the encrypted data contains image frames, and update information for deriving additional image frames by updating the image frames, the method comprising
constructing a list of data pointers to selected parts of the stream of encrypted data that contain image frames, each data pointer being associated with a selected one of the items of decryption information that enables decryption of the encrypted data pointed at by the pointer;
selecting, during replay, the parts of the stream pointed at by pointers in the list;
using the list to supply decryption information from the item associated with each pointer.

6. A method according to claim 1, the method comprising
decrypting the items of decryption information from the incoming data stream and re-encrypting the items of decryption information with a recording key prior to storage;
storing the reencrypted items of decryption information separately from the stream of encrypted data.
